(19) United States
(12) Patent Application Publication
(10) Pub. No.: US 2026/0077886 A1
(43) Pub. Date: Mar. 19, 2026

(54) BUOYANT HOSE

(71) Applicant: CONOCOPHILLIPS COMPANY, Houston, TX (US)

(72) Inventor: Shamim SULEMAN, Houston, TX (US)

(73) Assignee: CONOCOPHILLIPS COMPANY, Houston, TX (US)

(21) Appl. No.: 19/327,750

(22) Filed: Sep. 12, 2025

Related U.S. Application Data
(60) Provisional application No. 63/695,169, filed on Sep. 16, 2024.

(51) Int. Cl. B64U 10/30; A62C 33/04; B64U 101/25; B64U 101/47; E21B 19/22

(52) U.S. Cl. CPC B64U 10/30; A62C 33/04; E21B 19/22; B64U 2101/25; B64U 2101/47

(57) ABSTRACT

Buoyancy modules filled with gases lighter than ambient air are described that are used to lift hoses and other lines off the surface of the ground. These buoyancy modules can support any line above the ground, the line delivering a fluid or energy from a source to a target.

### PRIOR RELATED APPLICATIONS

This application claims priority to U.S. Ser. No. 63/695,169, filed on Sep. 16, 2024, and incorporated by reference in its entirety for all purposes.

### FEDERALLY SPONSORED RESEARCH STATEMENT

Not applicable.

### FIELD OF THE DISCLOSURE

The disclosure generally relates to buoyant hoses, their manufacture, and various uses for buoyant hoses.

### BACKGROUND OF THE DISCLOSURE

A 2008 United States Geological Survey estimates that areas north of the Arctic Circle have 90 billion barrels of undiscovered, technically recoverable oil and 44 billion barrels of natural gas liquids in 25 geologically defined areas. This represents 13% of the undiscovered oil in the world.

Although large petroleum reserves are available in the Artic, there are significant challenges that significantly increase the cost of their production, particularly offshore where drilling requires innovative technology. Obviously, weather, including ice, snow, wind and freezing temperatures has a significant impact on costs, particularly for heavy oil which is not pumpable at Artic temperatures. Short operating seasons also complicates logistics. Great distances to infrastructure, such as refineries, pipelines, electricity, housing and the like further contribute to high costs of production.

Petroleum exploration and production (E&P) operations in the Arctic also face concerns from organizations and governments about the potential for detrimental environmental consequences. To address these concerns, stringent regulations have been passed to protect the environment, and in some places a moratorium on drilling has been implemented.

Where E&P is allowed, operators are required to develop operational plans addressing all phases of a proposed Arctic exploration program and submit it in advance. The regulations require companies to have access to—and the ability to promptly deploy—source control and containment equipment, such as capping stacks and containment domes, while drilling below or working below the surface casing. Operators also must have access to a separate relief rig able to drill a timely relief well under the conditions expected at the site in the event of a loss of well control; have the capability to predict, track, report, and respond to ice conditions and adverse weather events; effectively manage and oversee all contractors; and develop and implement an oil spill response plan in a manner that accounts for the unique operating environment, and is supported with the necessary equipment, training, and personnel for a prompt response.

One of the many regulations in place is that hoses are not allowed to be dragged over the tundra. Thus, drone tethered hose systems have been developed where drones are attached to the hose and hold it up in the air. Each support drone partially supports the weight of the tether line and is operated by the drone system controller. See e.g., FIG. 1 (excerpted from U.S. Pat. No. 9,764,839). See also U.S. Pat. No. 11,325,702 and US20210138281, each incorporated by reference in its entirety for all purposes.

Although addressing the regulations, this approach requires a large number of drones to carry hose in the air, and the control systems needed to direct a large number of drones presents both significant costs and operational challenges.

Thus, what is needed in the art are better means of carrying hose above the tundra or other terrain. The ideal method would reduce the number of drones required, and passively support drone lifting, but at lower costs and with fewer operational challenges.

### SUMMARY OF THE DISCLOSURE

The invention is directed generally to buoyancy modules that can be coupled to a hose or line of any type, and provide passive lift, thereby reducing the number of drones needed for the lifting operation.

The buoyancy modules are simply lightweight cannisters or balloons that are filled with a lifting gas, such as hot air, hydrogen, helium, coal gas, ammonia, methane, and combinations thereof. The preferred gas is preferably not flammable or at least less flammable, lighter than air under the conditions of use, and non-toxic. Hot air, hydrogen, helium, methane, and the like have been used as lift gases.

Traditionally, helium has been the preferred lift gas due to its inert properties and safety considerations. However, the increasing demand and limited global helium reserves have prompted scientists to explore alternative lift gases, with hydrogen emerging as the most logical choice since hydrogen can be generated on site via electrolysis of water. Hydrogen is the only gas providing lift similar to helium, in fact, it provides about 7-8% more lift and is widely used in atmospheric sounding balloons outside North America.

Adopting hydrogen as a lift gas is not without challenges, however. Safety concerns, especially during the launch and recovery phases, are paramount. The scientific ballooning community, however, has been developing stringent safety protocols and engineering solutions to mitigate these risks. This development includes specialized support systems, leak detection mechanisms, and enhanced launch and recovery procedures. Additionally, environmental considerations must be carefully evaluated. Hydrogen release has the potential to increase concentrations of various greenhouse gases, and its usage risks must be balanced against its benefits.

Yet another option is the hot air balloon, where a propane tank heats the air needed to create lift. Hot air, depending on temperature, provides only 5-15% of the lift of helium. However, propane and other light end fuels may be readily available on site, as a byproduct of hydrocarbon production, but of course, any burning fuel will present its own safety hazards.

An alternate option may include the use of solar panels instead of burning fuel to keep the air hot. Weather ballons and spy balloons have already been outfitted with solar panels and this may be a viable option, at least while the sun is shining.

As yet another option, Geotectura has developed an array of helium filled platforms constructed from a new fabric coated with photovoltaic solar cells. Dubbed “Sunhope” they have constructed several prototypes and have conducted research to show that a 10 ft balloon could provide around a kilowatt of energy (equivalent to 25 square meters of solar panels) at a target cost of $4,000 per balloon which will last about a year without needing maintenance. While currently somewhat expensive for this application, costs will decrease as the technology is developed, and these balloons may be a viable option in the near future.

Methane (the other gas historically used for balloons) provides less than 48% of the lift of helium, and has 3.75 times the energy density, making it far more dangerous than hydrogen in the event of a fire. Nonetheless, methane is readily available at many drilling locations and may be suitable for use as a lifting gas. Other light end gases may also be used.

The cannisters themselves are made with any lightweight material that will hold the chosen gas and may comprise valves for adding gas thereto as well as one or more safety features, such as leak detection, temperature sensors, altimeters, and the like. Such cannisters may be e.g., aluminum, foil, plastics, such as latex and synthetic polymers, silk, and the like. The most commonly used material for storing helium is aluminum. It has a high strength-to-weight ratio and is able to contain helium without leaking for extended periods of time. It may be combined as a thin layer coating other lightweight materials to improve their resistance to leakage. Mylar, for example, is reflective because of a thin layer of aluminum on plastic film that reduces the permeation/leak rate.

In other embodiments, simple large weather balloons are attached to the line for lift. Here, the degree of leakage is less critical as the balloons are large enough to accommodate the daily leakage rates.

The cannisters or balloons are then attached to the hose or lines by any coupling means, or the containers themselves are toroidal or a hollow tube shaped, and the line fed through the hole. Indeed, one embodiment of a buoyancy module is in the shape of a hollow tube about 2-6 feet in length, a series of which can be fed over the line to be floated. With the use of foil, inexpensive tubal balloons can easily be created and a large number of these can significantly reduce the need for drones.

Reversable coupling means can range from simple holes, latches, hooks, to pulleys, treadmills, and the like. Preferred coupling means allow some degree of lateral movement of the hose with respect to the buoyancy module, allowing the hose to slide as the module lifts and lowers. Thus, a hook with a rotatable bearing is one simple coupling means. In another option, the hose may be coupled to a rotating pulley, as shown in FIG. 1B or a treadmill as in 1C. Ideally, a system that allows lateral motion is also equipped with a brake to prevent unwanted lateral motion.

The buoyancy modules are combined with drones—the drones allowing control over the line placement, but drone costs may be reduced as much as 50% if every other drone is replaced with a buoyancy module. Under low wind conditions, drone usage may be reduced even further. Further, since in the Artic both ends of the hose are grounded, it may even be possible to wholly eliminate drone usage, depending on the length of hose and wind conditions. By contrast, in a fire fighting context, control over the water delivery end is typically controlled by drone, since water is delivered above the fire and thus the delivery end floats. Thus, a fire-fighting buoyant hose system will likely retain the use of controllable drones, although fewer will be needed.

As yet another alternative, the buoyancy module may be added to a drone—the combined device providing passive lift as well as directional controllability. In this case, the buoyancy module is typically placed above the drone, although it may also be to either side or combinations thereof.

The buoyancy modules can be used wherever lines needed to be lifted off the surface for regulatory reasons or to avoid obstacles. Thus, the buoyancy modules may be used in urban fires or wildfires, for downhole operations, such as delivering fluids or electricity, for de-icing equipment from above, cleaning pipelines, and the like.

The invention includes any one or more of the following embodiment(s) in any combination(s) thereof, but each possible combination is not separately listed in the interests of brevity.
A buoyancy module for lifting a separate line above a ground surface, said buoyancy module comprising: a) a gas-tight container; b) a coupler configured to reversibly couple said container to said separate line; and c) said container filled with a gas of lower density than an ambient gas density outside of said container such that said container and said line are lifted above said ground surface.
A buoyancy module for lifting a separate line above a ground surface, said buoyancy module comprising: a) a gas-tight container; b) a coupler configured to reversibly couple said container to said separate line; c) said container filled with a gas of lower density than an ambient gas density outside of said container such that said container and said line are lifted above said ground surface; d) a gas valve for recharging said container with said gas; and e) a sensor-and-safety package operably coupled to said container.

Any buoyancy module described herein, said sensor-and-safety package comprising one or more of a gas leakage sensor, a temperature sensor, an alarm, a brake, an automatic shut off, a processor for recording data from the various sensor and safety devices, a processor for controlling the various sensor and safety devices, means for wireless communications, batteries, solar panels, and the like.

Any buoyancy module described herein, said container further comprising a gas leakage sensor.

Any buoyancy module described herein, said container further comprising a heater configured to heat said gas.

Any buoyancy module described herein, said container further comprising a temperature sensor.

Any buoyancy module described herein, said container comprising a latex balloon.

Any buoyancy module described herein, said container comprising a mylar balloon.

Any buoyancy module described herein, said gas-tight container operably coupled to an unmanned ariel vehicle.

Any buoyancy module described herein, said gas being hot air or helium or methane or hydrogen or combinations thereof.

Any buoyancy module described herein, wherein a plurality of such modules are used to effectuate said lift.
A system for exploring or producing petroleum from a well in an artic environment, said system comprising: a) a well under a surface in a petroleum reservoir; b) a line carrying a fluid or electricity from a source to said well; and c) said line supported at least in part above said surface by any one or more buoyancy modules described herein.
A system for delivering a electricity to equipment, said system comprising: a) equipment on a ground surface; b) a line carrying electricity from a source to said equipment; and c) said line supported at least in part above said ground surface by any one or more buoyancy modules described herein.
A system for delivering a fluid to equipment, said system comprising: a) equipment on or under a ground surface; b) a line carrying a fluid from a source to said equipment or above said equipment; and c) one or more optional unmanned aerial vehicles coupled to said line for controlling a movement of said line; d) said line supported at least in part above said ground surface by any one or more buoyancy modules described herein.
A system for fighting fires, said system comprising: a) a line carrying a firefighting fluid from a source to above said fire; b) said line supported at least in part above said fire by any one or more buoyancy modules described herein; and c) one or more unmanned aerial vehicles coupled to said line for controlling a movement of said line above said fire.
A method of producing petroleum from a well in an artic environment, said method comprising: a) providing a well under a surface in a petroleum reservoir; b) providing a line carrying a fluid or electricity from a source to said well; c) supporting said line at least in part above said surface by any one or more buoyancy modules described herein; and d) producing petroleum from said well.
A method of fighting fire, said method comprising: a) providing a line carrying a firefighting fluid from a source to above said fire; b) supporting said line above said fire by any one or more buoyancy modules described herein; and c) controlling a movement of said line by one or more unmanned aerial vehicles; and d) delivering said fluid to said fire to reduce or eliminate said fire.
A method of lifting a line above a ground surface, said method comprising attaching a line to any one or more buoyancy modules described herein, thereby supporting said line at least in part above said surface, said line carrying electricity or fluid or information from a source to a target.

As used herein, “a lifting gas” or lighter than air gas means a gas that has a density lower than normal atmospheric gases and rises above them as a result, making it useful in lifting lighter-than-air aircraft or the buoyancy modules described herein. Only certain lighter than air gases are suitable as lifting gases. Dry air has a density of about 1.29 g/L (gram per liter) at standard conditions for temperature and pressure (STP) and an average molecular mass of 28.97 g/mol, and so lighter-than-air gases have a density lower than this. The density increases as temperature decreases, as indicated in Table 1.

TABLE 1
AIR DENSITY AT STANDARD TEMPERATURE
ANS PRESSURE (STP)

| | | Density | Maximum |
|---|---|---|---|
| Temperature | Temperature | dry air | water content |
| (° C.) | (° F.) | [kg/m³] | [kg/m³] |
| −25 | −13 | 1.423 | |
| −20 | −4 | 1.395 | |
| −15 | 5 | 1.368 | |
| −10 | 14 | 1.342 | |
| −5 | 23 | 1.317 | |
| 0 | 32 | 1.292 | 0.005 |
| 5 | 41 | 1.269 | 0.007 |
| 10 | 50 | 1.247 | 0.009 |
| 15 | 59 | 1.225 | 0.013 |
| 20 | 68 | 1.204 | 0.017 |
| 25 | 77 | 1.184 | 0.023 |
| 30 | 86 | 1.165 | 0.030 |
| 35 | 95 | 1.146 | 0.039 |
| 40 | 104 | 1.127 | 0.0351 |

STP = density of dry air at standard atmospheric pressure at sea level at 15°

Fire resistant gases such as bromotrifluoromethane, bromochloromethane, trifluoroiodomethane, or the like may be used as lifting gases, and help reduce fire risks if warmed to increase buoyancy. Alternatively, they may be combined with other gases such as helium, hydrogen or methane.

As used herein a “gas-tight” container holds the gas in question, although a slow degree of leaking is likely unavoidable with the smaller gases. Nonetheless, the container should hold sufficient gas for buoyant operation for at least the daylight hours, and preferably at least 12 or 24 hours.

As used herein, the term “container” includes both solid containers such as cannisters, as well as expandable and flexible containers, such as balloons. Cannisters includes all solid containers, and balloons includes any expandable and flexible containers. Utilizing a dark colored container with a lifting gas may also improve buoyancy in sunny climes if the dark container is configured to absorb heat.

As used herein, the lifted “line” is any line that carries any component or information from one place to another. This line will most frequently carry fluid, energy, such as electricity, or signals, such as wireline signals.

As used herein, the “fluid” being delivered by the lifted line may be a firefighting fluid, water, brine, a cleaning solution, a de-icing solution, a well stimulation fluid, and the like.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed, and excludes all additional elements. The phrase “consisting essentially of” excludes additional material elements, but allows the inclusions of non-material elements that do not substantially change the nature of the invention, such as instructions for use, safety features, and the like.

Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

| ABBREVIATION | TERM |
|---|---|
| E&P | Oil exploration and/or production |
| STP | Standard temperature and pressure |
| UAV | Unmanned Aerial Vehicle |
| VR | Virtual reality |

### BRIEF DESCRIPTION OF THE DRAWINGS

FIG. 1A Prior art: Drone system for lifting hose lines above the terrain.

FIG. 1B Prior art: Drone with pulley for movingly holding hose. The pulley allows the drone to slide along the hose.

FIG. 1C Prior art: Drone with treadmill for movingly holding hose.

FIG. 2A-D Various buoyancy modules.

FIG. 3A Buoyancy module and drone combination.

FIG. 3B Buoyancy module and drone combination system for lifting hose lines to spray powerlines or other equipment, e.g., for de-icing.

FIG. 4 and FIG. 5 Buoyancy module and drone combination system for lifting hose lines above the terrain in an oil exploration and/or production (E&P) application.

### DETAILED DESCRIPTION

The disclosure provides novel buoyancy modules for lifting hoses and other lines off the ground. These buoyancy modules may be used together with drones for directional control, or they may be combined with a drone so the combined device provides both lift and control. In some cases, drone usage may be omitted entirely. Such devices have uses to carry hoses and other lines in the Artic, or in the forest for e.g., firefighting, or anywhere where line lift off the ground would be beneficial.

The choice of lift gas may vary in a fire context, where the explosive risk is significant. Thus, helium may be used for firefighting, but a much broader ranges of gases is applicable in an E&P context.

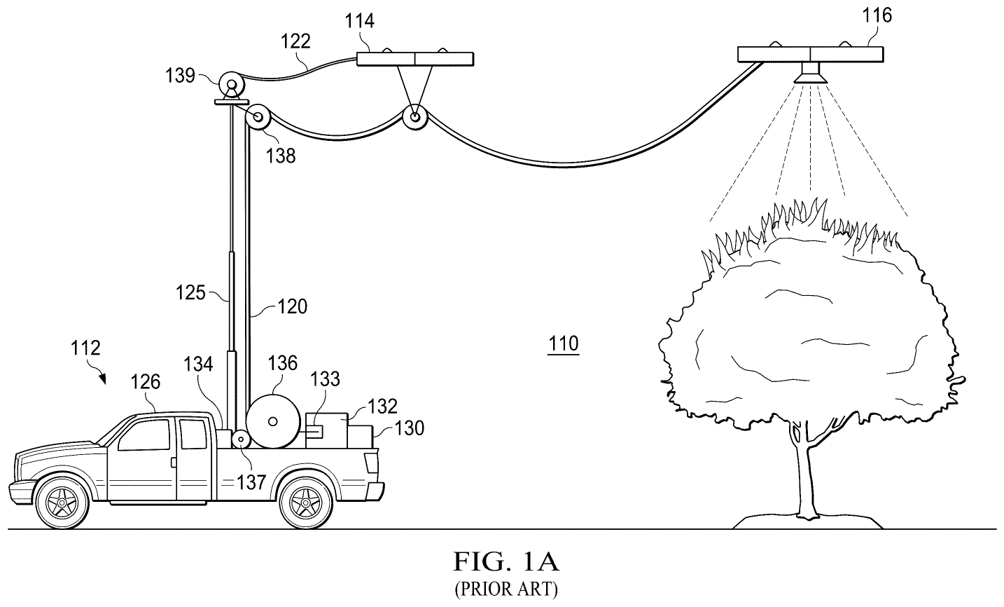

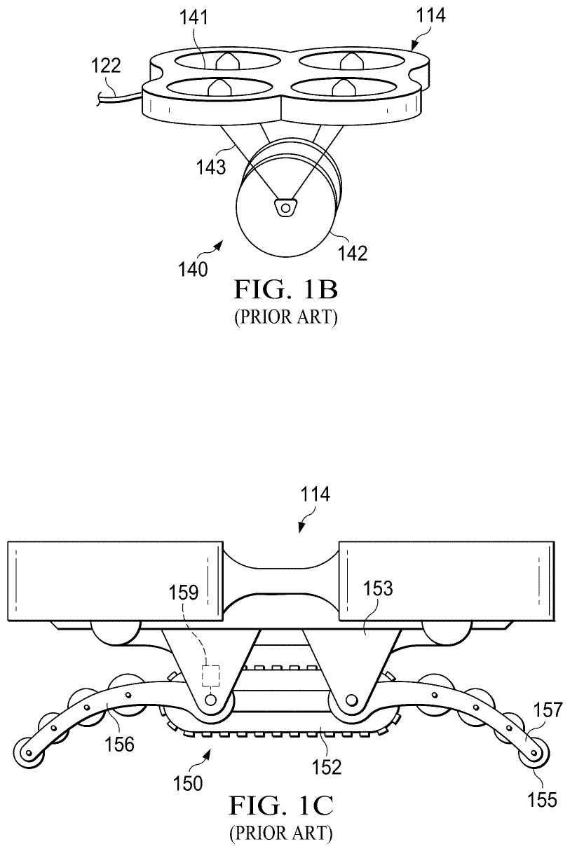

FIG. 1A shows the prior art drone support system 110 for a firefighting hose (excerpted from U.S. Pat. No. 9,764,839). Control station 112 includes a vehicle 126 carrying tower 125, a power source 130 such as a battery array, generator, and the like, a tank 132 containing the firefighting liquid, such as water, water with chemical fire retardant, slurry or the like, a pump 133 coupled to tank 132 to pump the fluid, and a control unit 134 for controlling the operation of lifting drone 114 and firefighting drone 116.

Drones 114 and 116 can be controlled over a control wire carried by power line 122 and/or tether line 120, or, as preferred, by remote control units well known in the art. In the preferred embodiment, drones 114 and 116 are remotely controlled by e.g., an Oculus Rift type virtual reality system with 360-degree view cameras carried by the drones. Tether/hose line 120 and power line 122 are used to provide endless power from power source 130 to drones 114 and 116, allowing them to stay airborne for extended, if not unlimited periods of time. Electrical power is the preferred power source, but it will be understood that chemical power, such as gasoline may be employed instead, or solar power may be used.

Tower 125 is mounted on vehicle 126 with tether/hose line 120 carried on a spindle 136 mounted on vehicle 126. Line 120 can be unrolled from spindle 136 as needed and is supported at the top end of tower 125 by a tower pulley 138. Line 120 continues from pulley 138 to lifting drone 114 and terminates at firefighting drone 116, thereby delivering the firefighting fluid above the fire. As firefighting drone 116 is moved outwardly from control station 112, line 120 is deployed from spindle 136, and movably supported by pulley 138 and lifting drone 114.

An additional pulley 139 is mounted on the upper end of tower 125 to movably support power line 122 for supplying power to lifting drone 114. Power line 122 is carried by another spool 137 on vehicle 126 and coupled to power supply 130.

Turning now to FIG. 1B, lifting drone 114 is illustrated. Lifting drone 114 is preferably a quadcopter unmanned aerial vehicle (“UAV”), but it will be understood that substantially any drone with vertical takeoff and landing capability can be employed. As an example, lifting drone 114 is approximately 12 feet in length, has a payload lifting capacity of 1000 lbs, and is remotely piloted through a Virtual Reality (VR) system. Lifting drone 114 includes drive motors, which in this embodiment are four electric motors driving rotors 141. Power line 122 is coupled to the drive motors to provide substantially unlimited flight time. However, other power means may be used, including batteries, solar power, and the like, and communications may be wired or preferably wireless.

Lifting drone 114 is not described in detail as UAVs are well known in the art. This is a UAV that has been modified to include a tether line support assembly 140. In its simplest form, the tether/hose line support assembly 140 includes a pulley 142 supported below lifting drone 114 by a bracket 143. Bracket can be foldable or collapsible to permit landing of lifting drone 114. Line 120 is positioned over pulley 142, and is thereby supported by lifting drone 114 while permitting lifting drone 114 to move along line 120 intermediate tower 125 and firefighting drone 116.

Referring now to FIG. 1C, another embodiment of lifting drone 114 is illustrated. In this embodiment, lifting drone 114 is a UAV modified to include a tether/hose line support assembly 150. Line support assembly 150 includes a gripping mechanism 152 suspended below lifting drone 114 by brackets 153. Gripping mechanism 152 is slip resistant, treaded or similarly treated to provide a high friction surface allowing line 120 to be supported while increasing the friction at the interface between tether 120 and gripping mechanism 152 to reduce slippage. Gripping mechanism 152 is similar to a small conveyor belt or treadmill, and can be locked (brake not visible herein) in a holding position for stationary positioning along tether line 120 or released to rotate in a direction desired to move lifting drone 114 along the length of tether line 120. It could even be powered to drive the drone along line 120.

Gripping mechanism 152 can be driven, or simply allowed to rotate as drone 114 is repositioned. A tether line weight distribution feedback system 155 is carried by lifting drone 114 and includes support levers 156 and 157 extend from opposing ends of gripping mechanism 152. Support levers 156 and 157 are spring loaded and biased to a substantially horizontal position as illustrated. Levers 156 and 157 are flexed to an increasingly lowered position by an increasing weight of tether 120 running thereover. Sensors 159 provide continuous feedback on the balance between levers 156 and 157, indicating when the weight is disproportionately to one side or the other of lifting drone 114. When an unacceptable imbalance is detected, drone 114 can be repositioned along the length of tether 120 to more effectively support it and balance the weight. This is accomplished by driving the rotating gripping mechanism to drive the line in the desired direction or unlocking the gripping mechanism to allow it to rotate as lifting drone 114 is moved along line 120.

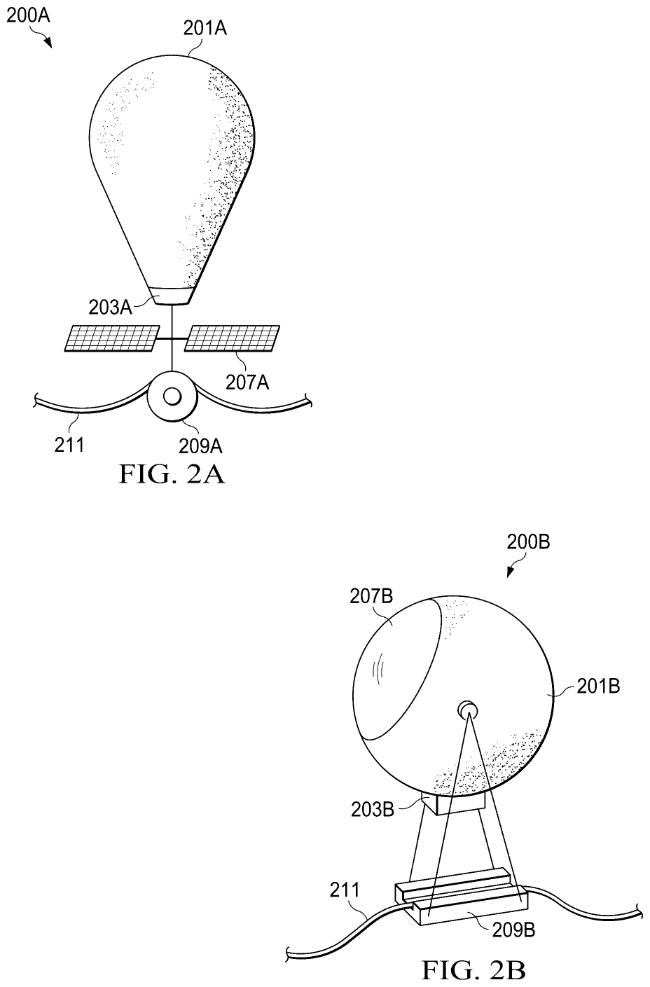

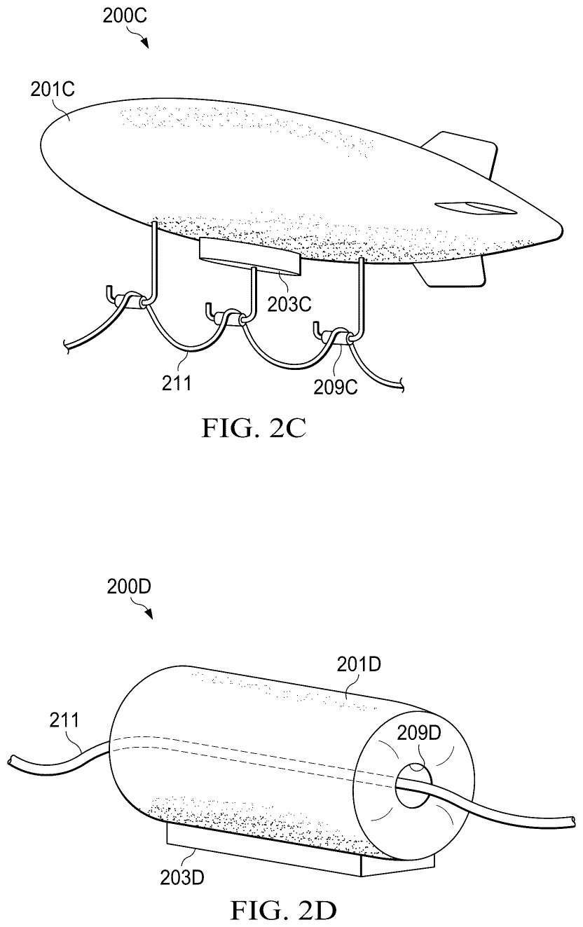

In FIG. 2A-D we see various buoyancy modules 200A-D as invented herein. Illustrated are containers (cannisters or balloons) 201A-D, sensor-and-safety packages under balloon 203A-D, solar panels 207A, 207B, line coupling means 209A-D, and hose or line 211. Although the sensor-and-safety package 203A-D is shown under the cannister/balloon 201A-D, the position can vary as convenient. Thus, it may be to the side, or on top of the containers 201A-D.

Sensor-and-safety packages 203A-D may comprise the needed sensor and safety elements needed for safe operation of the gas being used. They may contain one or more of a gas leakage sensor, a temperature sensor, an alarm, a brake, an automatic shut off, an automatic gas purger, and the like. Control modules, if present, are also typically found in this package, although they may be separate if desired.

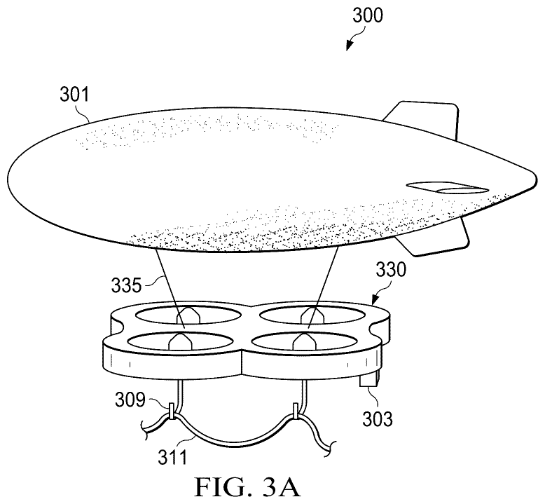

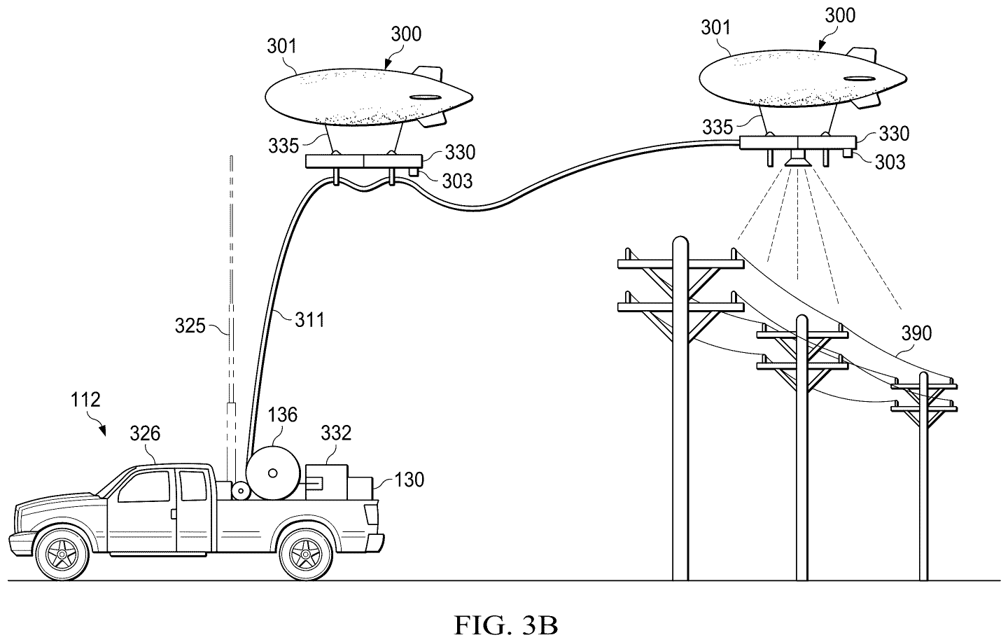

FIG. 3A shows a combined buoyancy module and drone 300, with container 301, sensor-and-safety package 303 on drone 330, drone coupling lines 335 for coupling the drone to the container 301, coupling means (here hooks) for hose 309, and finally hose or line 311.

FIG. 3B shows the device of FIG. 3A included with a system similar to that seen in FIG. 1A, with truck 326, optional tower 325 which can be replaced by one or more buoyancy modules 300. Here two buoyancy and drone modules 300 are shown, and the hose 311 reaches from tank 332 to spray powerlines 390 or other equipment, e.g., for de-icing.

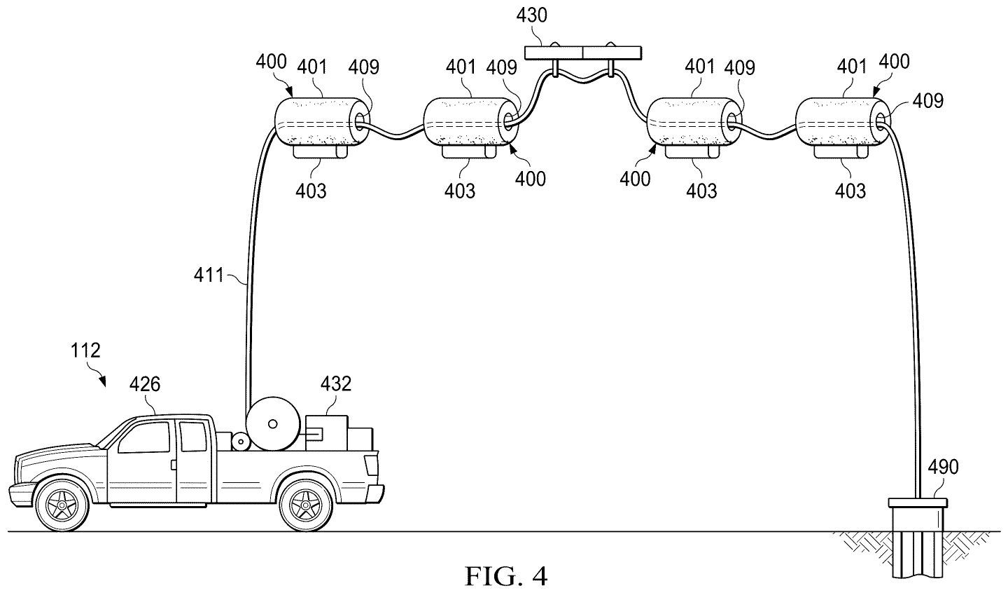

FIG. 4 shows a tubular buoyancy module 400 per FIG. 2D, with balloons 401, sensor/safety package on balloon 403, coupling means (hole) for hose 409, and hose or line 411. Truck 426 hosts tank 432 and the hose 411 reaches from tank 432 down to oil well 490. Here four buoyancy modules 400 are shown with one centrally located optional drone 430 for controlling the hose position.

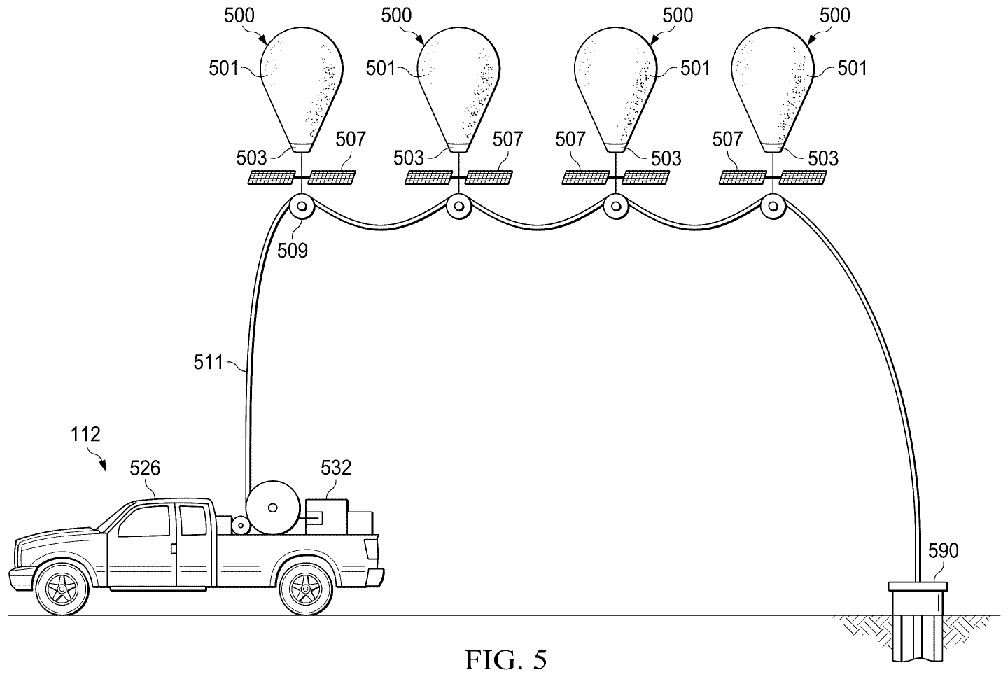

FIG. 5 shows a buoyancy module 500 per FIG. 2A, with balloon 501, sensor/safety package on balloon 503, solar panels 507, coupling means (hooks) for hose 509, and hose or line 511. Truck 526 hosts tank 532 and the hose 511 reaches from tank 532 down to oil well 590. Here four buoyancy modules 500 are shown and no drone is needed.

The present invention is exemplified with respect to hydrogen gas buoyancy modules. However, this is exemplary only, and the invention can be broadly applied to any lifting gas. The following examples are intended to be illustrative only, and not unduly limit the scope of the appended claims.

The following references are incorporated by reference in their entirety.
U.S. Pat. No. 9,764,839 Tethered unmanned aerial vehicle fire-fighting system
U.S. Pat. No. 11,325,702 Tethered aerial drone system
US20210138281 Fire-fighting system using drone

1) A buoyancy module comprising:
a) a gas-tight container;
b) a coupler configured to reversibly couple said container to a separate line; and
c) said container filled with a gas of lower density than an ambient gas density outside of said container such that said container and said separate line are lifted above a ground surface.

2) The buoyancy module of claim 1, said container further comprising a gas valve for recharging said container with said gas.

3) The buoyancy module of claim 1, said container further comprising a gas leakage sensor or a temperature sensor or both.

4) The buoyancy module of claim 1, said container further comprising a heater configured to heat said gas.

5) The buoyancy module of claim 1, said container being toroidal with a hole therethrough and said coupler being said hole.

6) The buoyancy module of claim 1, said container comprising a latex balloon or a mylar balloon.

7) The buoyancy module of claim 1, said gas-tight container operably coupled to an unmanned ariel vehicle.

8) The buoyancy module of claim 1, said gas being hot air or helium or methane or hydrogen or combinations thereof.

9) A buoyancy module comprising:
a) a gas-tight container;
b) a coupler configured to reversibly couple said container to a separate line;
c) said container filled with a gas of lower density than an ambient gas density outside of said container such that said container and said separate line are lifted above said ground surface;
d) a gas valve for recharging said container with said gas; and
e) a sensor-and-safety package operably coupled to said container.

10) A system for exploring or producing petroleum from a well in an artic environment, said system comprising:
a) a well under a surface in a petroleum reservoir;
b) a line carrying a fluid or electricity from a source to said well; and
c) said line supported at least in part above said surface by one or more buoyancy modules of claim 1.

11) A system for exploring or producing petroleum from a well in an artic environment, said system comprising:
a) a well under a surface in a petroleum reservoir;
b) a line carrying a fluid or electricity from a source to said well; and
c) said line supported at least in part above said surface by one or more buoyancy modules of claim 5.

12) A system for exploring or producing petroleum from a well in an artic environment, said system comprising:
a) a well under a surface in a petroleum reservoir;
b) a line carrying a fluid or electricity from a source to said well; and
c) said line supported at least in part above said surface by one or more buoyancy modules of claim 9.

13) A system for fighting fires, said system comprising:
a) a line carrying a firefighting fluid from a source to above said fire;
b) said line supported at least in part above said fire by one or more buoyancy modules of claim 1; and
c) one or more unmanned aerial vehicles coupled to said line for controlling a movement of said line above said fire.

14) A system for fighting fires, said system comprising:
a) a line carrying a firefighting fluid from a source to above said fire;
b) said line supported at least in part above said fire by one or more buoyancy modules of claim 5; and
c) one or more unmanned aerial vehicles coupled to said line for controlling a movement of said line above said fire.

15) A system for fighting fires, said system comprising:
a) a line carrying a firefighting fluid from a source to above said fire;
b) said line supported at least in part above said fire by one or more buoyancy modules of claim 9; and
c) one or more unmanned aerial vehicles coupled to said line for controlling a movement of said line above said fire.

16) A method of producing petroleum from a well in an artic environment, said method comprising:
a) providing a well under a surface in a petroleum reservoir;
b) providing a line carrying a fluid or electricity from a source to said well;
c) supporting said line at least in part above said surface by one or more buoyancy modules of claim 1; and
d) producing petroleum from said well.

17) A method of producing petroleum from a well in an artic environment, said method comprising:
a) providing a well under a surface in a petroleum reservoir;
b) providing a line carrying a fluid or electricity from a source to said well;
c) supporting said line at least in part above said surface by one or more buoyancy modules of claim 5; and
d) producing petroleum from said well.

18) A method of producing petroleum from a well in an artic environment, said method comprising:
a) providing a well under a surface in a petroleum reservoir;
b) providing a line carrying a fluid or electricity from a source to said well;
c) supporting said line at least in part above said surface by one or more buoyancy modules of claim 9; and
d) producing petroleum from said well.

19) A method of lifting a line above a ground surface, said method comprising attaching a line to one or more buoyancy modules of claim 1, thereby supporting said line at least in part above said surface, said line carrying electricity or fluid or information from a source to a target.

20) The method of claim 19, further comprising attaching one or more unmanned aerial vehicles to said line.
